(19) United States
(12) Patent Application Publication
(10) Pub. No.: US 2013/0062461 A1
(43) Pub. Date: Mar. 14, 2013

(54) NACELLE FOR AN AIRCRAFT ENGINE

(71) Applicant: Aircelle, Gonfreville L'Orcher (FR)

(72) Inventors: Alexandre BELLANGER, Le Havre (FR); Florent Bouillon, Anglesqueville L'Esneval (FR); Laurent Dubois, Le Havre (FR); Emmanuel Anfray, Saint Martin du Manoir (FR)

(73) Assignee: Aircelle, Gonfreville L'Orcher (FR)

(21) Appl. No.: 13/662,886

(22) Filed: Oct. 29, 2012

Related U.S. Application Data
(63) Continuation of application No. PCT/FR2011/050506, filed on Mar. 14, 2011.

(30) Foreign Application Priority Data
Apr. 29, 2010 (FR) 10/53343

(51) Int. Cl. B64D 27/26; B64D 29/00

(52) U.S. Cl. 244/54

(57) ABSTRACT

A supporting half-structure for an aircraft engine nacelle is provided that includes at least one longitudinal beam and a front half-frame connected to each other and formed at least partly in composite materials. The half-structure includes a connecting hinge positioned in a junction area of the longitudinal beam and of the half-frame, the hinge being formed by composite materials laid out so that fibres of the composite materials are positioned in alignment with fibres of composite materials forming said front half-frame.

### CROSS-REFERENCE TO RELATED APPLICATIONS

This application is a continuation of International Application No. PCT/FR2011/050506 filed on Mar. 14, 2011, which claims the benefit of FR 10/53343, filed on Apr. 29, 2010. The disclosures of the above applications are incorporated herein by reference.

### FIELD

The present invention relates to the field of nacelles for aircraft engines.

### BACKGROUND

The statements in this section merely provide background information related to the present disclosure and may not constitute prior art.

As this is known per se, an aircraft engine, which generally is of the turbine engine type, is placed inside a nacelle which, among other functions:

ensures aerodynamic fairing of the engine,

allows channelling of outside air towards the engine,

allows the engine to be connected to the aircraft.

Conventionally, the connection of the engine to the aircraft is made by means of a supporting structure comprising two upper longitudinal beams, often called 12 o'clock beams because of their position at the top of the nacelle, two lower longitudinal beams, conventionally called 6 o'clock beams because of their position in the lower portion of the nacelle, and an assembly having a substantially annular shape called a front frame, in reality, formed with two half-frames each extending between said upper and lower longitudinal beams, and intended to be attached to the periphery of the downstream edge of the fan case of the engine.

Such a conventional configuration is visible in FIG. 1 appended herein, where a rear nacelle portion has been illustrated, incorporating in this case a thrust reverser, this rear portion comprising:

two 12 o'clock beams 1a, 1b,

two front half-frames 3a, 3b, connected to both 12 o'clock beams 1a, 1b respectively and supporting deflection grids 5a, 5b,

two half-cowls 7a, 7b each slidably mounted respectively on a 12 o'clock beam 1a, 1b so as to be able to expose the deflection grids 5a, 5b with view to achieving thrust reversal.

As this known per se, during thrust reversal, the air A1 from the fan (not shown) and circulating inside the secondary flow vein 9, flows through the grids 5a, 5b and is discharged towards the front of the nacelle, as indicated by the arrow A2.

For the sake of a gain in mass, notably, much work during these recent years has been dealing with solutions in composite materials for the 12 o'clock longitudinal beams 1a, 1b and the 6 o'clock longitudinal beams and the front half frames 3a, 3b.

One of the difficulties encountered with this selection of materials notably lies in the making of connecting hinges, notably between both 12 o'clock beams 1a, 1b: indeed, conventionally, provision has to be made on each beam 1a, 1b for a hinge respectively located at right angles to each front half-frame 3a, 3b, often designated as hinge R1, allowing the placement of a connecting rod between both of these beams, so as to spread the different forces tending to separate both of these beams from each other.

These forces notably comprise circumferential forces from the beams 1a, 1b of the half-frames 3a, 3b as well as torsional and flexural moments due to the position of the hinges R1 on each beam 1a, 1b.

These hinges R1 are particularly subject to stress because of their positions at the junction between their respective beams 1a, 1b and the respective front half-frames 3a, 3b.

These particular positions give these hinges R1 a role different from those of the other hinges in terms of how they respond to forces and transmit them: these hinges have a particularity of mainly spreading forces from front half frames 3a, 3b.

This is explained by the fact that the connecting rod between both hinges R1 has the function of [symbol] closing [symbol] both front half-frames which surround the engine case; in order to optimize the transmission of forces, the hinges R1 are traditionally aligned on the plane of inertia of the frame formed by both front half-frames 3a, 3b.

### SUMMARY

The present invention provides hinges R1 having increased resistance towards the forces as set forth above, in an assembly of 12 o'clock beams and of front half-frames formed with composite materials.

The present disclosure is thus notably directed to integrating the hinges R1 to the junction of each 12 o'clock beam and of its associated front half-frame, the complexity being optimization of the transmission of the forces, most particularly in a front frame with an open section formed in composite materials.

Similar problems are encountered in the connecting areas of the 6 o'clock beams with the front half-frames, where provision has to be made for hinges allowing placement of locks for closing both front half-frames.

The present disclosure is therefore also directed to integrating these hinges at the junction of each 6 o'clock beam with its associated front half-frame.

This is achieved with a supporting half-structure for an aircraft engine nacelle, comprising at least one longitudinal beam and a front half frame connected to each other and formed at least partly in composite materials, remarkable in that it comprises a connecting hinge positioned in the junction area of this beam and of this half-frame, this hinge being formed by composite materials positioned so as to form the volume of said hinge on the one hand, and so that their fibres are positioned in the continuity of the fibres of the composite materials forming said front half-frame on the other hand.

This particular arrangement gives the possibility of ensuring continuity of the fibres of the composite materials forming the hinge with those of the composite materials forming the front half-frame, which ensures excellent transmission of the forces notably between the front half frame and the hinge.

It should be noted that the hinges and the front half frames may be formed by stacking fabrics, or else by 2D or 3D weaving, among other manufacturing techniques.

According to other optional features of the supporting half-structure:

said beam is a 12 o'clock beam;

said beam is a 6 o'clock beam;

the downstream portion of said hinge is located at right angles to the downstream portion of said front half-frame: this configuration ensures improved transmission of the forces between the front half frame and the hinge;

the fibres of the composite materials forming said hinges converge towards each other, the space defined by this convergence being filled with foam: this foam, which has some hardness for a very low weight, contributes to the strength of the whole of the structure; it should be noted that it is also possible to envision the replacement of the foam with a vacuum, or further with a honeycomb structure, and more generally with any core material;

the fibres forming the upstream portion of said hinge are continuous with the fibres forming a stiffener of said front frame located in proximity to said junction area; this link of the hinge with the first stiffener of the front half-frame contributes to the strength of the connection between these members;

said hinge is laid on said beam, and the fibres forming these respective components are intimately bound: this configuration ensures improved transmission of the forces between the beam and the front half-frame;

said hinge is of the female type and includes a downstream yoke and an upstream yoke, each pierced with an orifice for attaching a connecting rod;

said hinge is of the male type and defines a block of composite material pierced with an orifice for attaching a connecting rod.

The present disclosure also relates to a nacelle for an aircraft engine, remarkable in that it comprises two half structures in accordance with the foregoing.

### DRAWINGS

Other features and advantages of the present invention will become apparent in the light of the description which follows, and upon examining the figures appended herein, wherein:

FIG. 1 illustrates a perspective view of a rear nacelle portion from the prior art, including a thrust reversal system, and described in the preamble of the present description,

FIG. 2 illustrates a partial top view of a left 12 o'clock beam 12 of the rear nacelle portion of FIG. 1, and of its associated left front half-frame,

FIG. 3 illustrates, in a top view similar to that of FIG. 2, an assembly of left 12 o'clock beams and its associated left front half-frame, this assembly being made according to the precepts of the present disclosure,

FIG. 4 illustrates the assembly of FIG. 3 in a perspective view,

FIG. 5 illustrates, at a larger scale, the half structure of FIGS. 3 and 4, in a sectional view along a plane parallel to the plane XY at the height indicated by the line P visible in FIG. 4,

FIG. 6 is a similar view to that of FIG. 4, showing the different modules making up the half-structure illustrated in FIGS. 3 to 5,

FIG. 7 is a perspective view of one of the modules forming a portion of the hinge of the half structure of FIGS. 3 to 7,

FIG. 8 is a perspective view of another module forming the upstream portion of the hinge of the half structure of FIGS. 3 to 6,

FIG. 9 is a perspective view similar to that of FIG. 4 of another embodiment of the half structure according to the present disclosure, and

FIG. 10 is a perspective view of still another embodiment of the half structure according to the present disclosure.

On the whole of these figures, an XYZ reference system is illustrated, the axes of which respectively represent the longitudinal, transverse and vertical directions of the nacelle, these directions being understood as being relative to the aircraft to which this nacelle has to be attached.

It should be noted that the arrow of the X axis is oriented from the downstream to the upstream portion of a nacelle.

The drawings described herein are for illustration purposes only and are not intended to limit the scope of the present disclosure in any way

### DETAILED DESCRIPTION

The following description is merely exemplary in nature and is not intended to limit the present disclosure, application, or uses. It should be understood that throughout the drawings, corresponding reference numerals indicate like or corresponding parts and features.

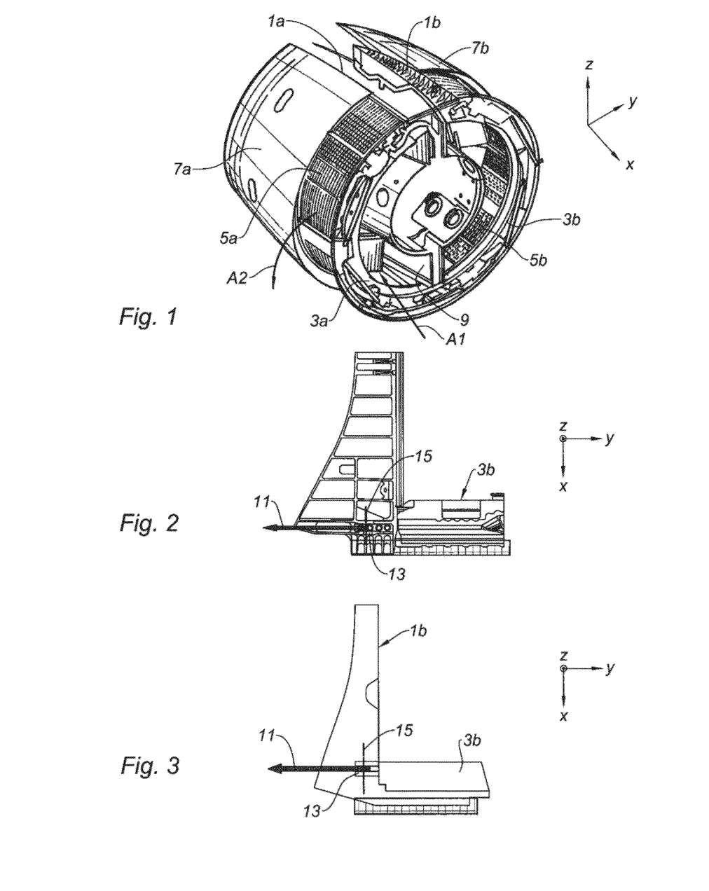

In FIG. 2, the left 12 o'clock beam 1b of the reverser portion illustrated in FIG. 1, and its associated front half frame 3b, are illustrated.

This half structure is of a quite conventional type, i.e. the beam 1b and the front half-frame 3b are formed by a combination of metal and composite materials.

As indicated in the preamble of the present description, the left beam 1b should be connected to the right beam 1a through a connecting rod exerting a force oriented along the arrow 11 of FIG. 2, and co-operating with a hinge 13 secured to the left beam 1b, while being jointed relatively to this hinge around an axis 15 (it being understood that this rod co operates with a similar hinge secured to the other beam 1a).

In the foregoing, we shall focus on the left half structure formed by the beam 1b and its associated front half-frame 3b, but of course it is a matter of fact that the right beam 1a and its associated front half-frame 3a have quite similar features.

Within the scope of the present disclosure, and as this is illustrated in FIGS. 3 to 11, the choice was made to form the beam 1b and its associated front half-frame 3b in composite materials. These composite materials may conventionally comprise fabrics with carbon fibres pre-impregnated with polymerizable resin, which are placed in suitable molds with polymerisable resin, and for which the temperature is raised in order to obtain hardening.

Alternatively, the composite materials may be obtained by methods of the LCM (Liquid Composite Molding) type notably grouping RTM (Resin Transfer Molding) and LRI (Liquid Resin Infusion) methods. The dry preform may be obtained by 2D or 3D weaving, by braiding, by automatic deposition of fibres (webs for example), or further by stacking fabrics.

In the first form illustrated in FIGS. 3 to 8, the hinge 13 is of the female type, i.e. it includes a front yoke 13a and an upstream yoke 13b, the terms of [symbol] downstream [symbol] and [symbol] upstream [symbol] should be understood relatively to the circulation of the air inside the nacelle, as indicated by the arrow A1 of FIG. 1.

Both yokes 13a and 13b are provided with orifices 15 intended to receive a material axis allowing attachment of a rod for connecting both 12 o'clock beams 1a and 1b.

As this is visible in FIG. 5, the fibres 16a and 16b of the composite materials, respectively forming the yokes 13a and 13b of the hinge 13, are respectively positioned in the plane and upstream from the fibres 17 of the composite materials forming the structure of the front half-frame 3b.

More specifically, the fibres 16a and 16b are closer to each other in a convergence area 19, so as to be located in the continuity of the fibres 17.

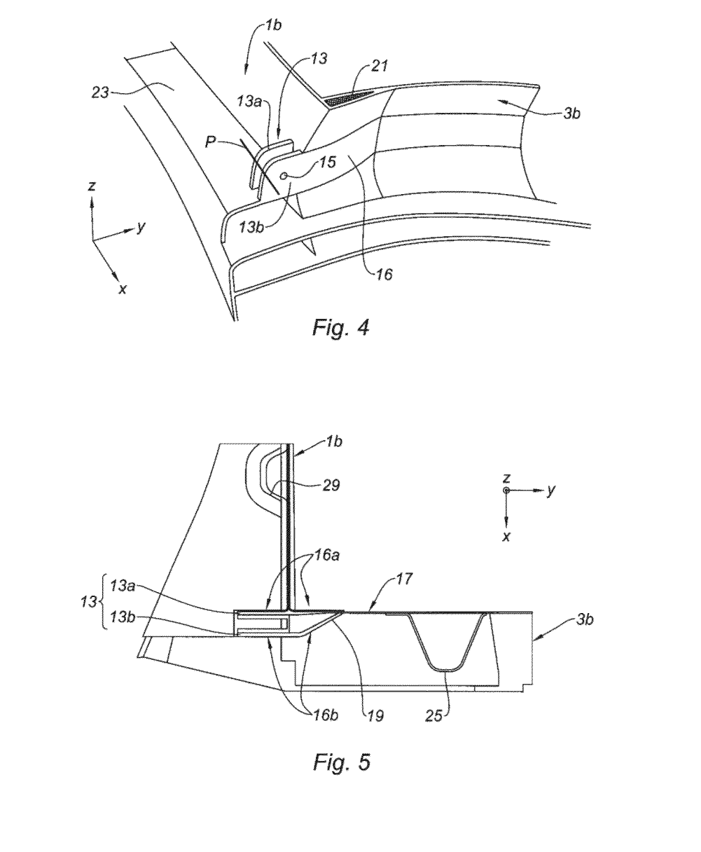

The hollow space defined by the convergence area 19 is preferably filled with lightweight structuring foam, such as a polyurethane foam 21, as illustrated in FIG. 4.

Preferably, the fibres 16a and 16b are moreover intimately bound with the fibres of the composite materials forming a horizontal band 23 of the beam 1b (see FIG. 4) so that the hinge 13 is both laid on this band 23 and secured thereto.

As this may be understood in the light of the foregoing, the fact that the fibres 16a, 16b of the composite materials forming the yokes 13a and 13b of the hinge 13 converge towards each other and coincide with fibres forming the structure of the front half-frame 3b by which it is possible to obtain excellent continuity of fibres between these different parts, which gives great strength to the hinge 13 and thus allows excellent transmission of forces from the beam 1b and from the front half-frame 3b to the hinge 13, and to its associated connecting rod (not shown).

The converging shape of the fibres 16b of the hinge towards the fibres 17 forming the structure of the front half frame 3b, gives the possibility of having these fibres 16b play the function of a stiffener of the front frame half-structure, in the same way as the other stiffeners 25 (see FIG. 5) regularly distributed over this front half-frame.

In this way, increased strength of the whole of the half structure is obtained and in particular of the area of the hinge 13.

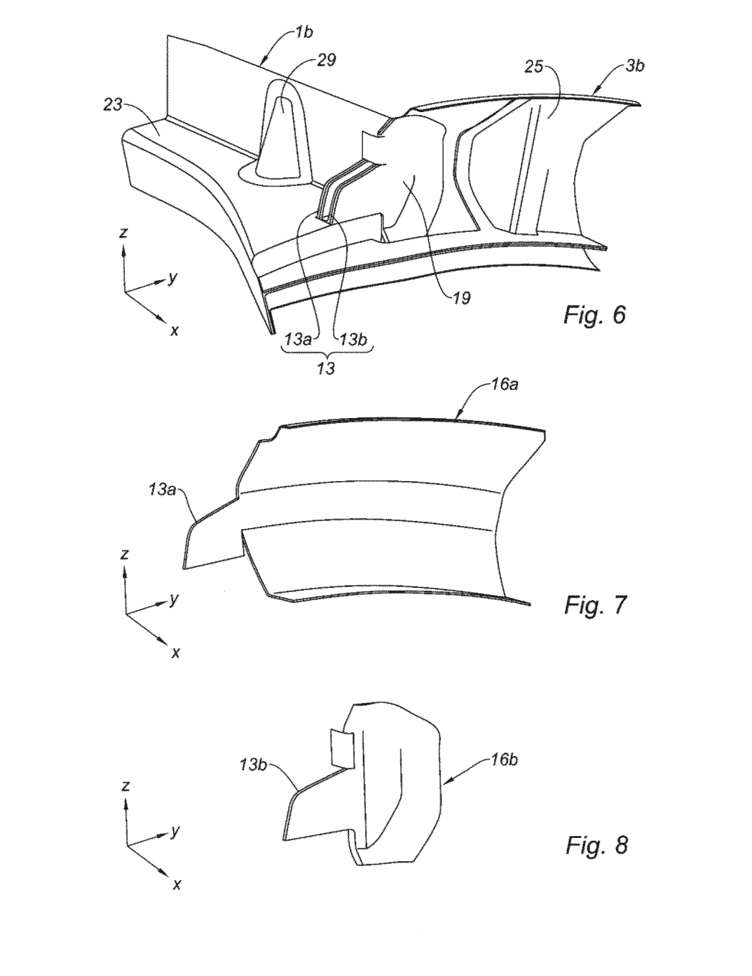

As this may be seen on the whole of FIGS. 6 to 8, the structure which has just been described may be formed from modules of composite materials, each module being indicated by a different screen on the whole of these figures.

More specifically, as illustrated in FIG. 7, a single and same module 16a may be used for forming the downstream yoke 13a of the hinge 13 and a portion of the structure of the front half-frame 3b, and another module 16b may be used for forming the upstream yoke 13b of the hinge 13, as well as the first stiffener of the front half-frame 3b.

Other modules may then be used for forming the other stiffeners 25 of the front half-frame 3b, the beam 1b as well as its stiffeners 29 (see FIG. 6).

Of course, the present invention is by no means limited to the described and illustrated embodiments.

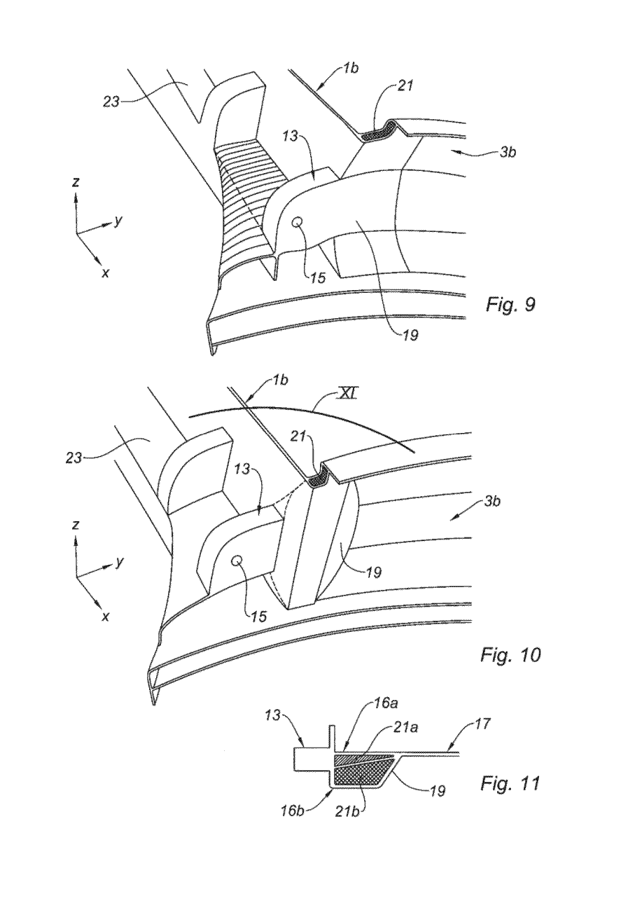

Thus, another form may be seen in FIG. 9, wherein the hinge 13 is of the male type i.e. it is solid and provided with an orifice 15 intended to receive a material axis, itself intended to co-operate with a bracket for attaching the connecting rod to the other beam (bracket and connecting rod not shown).

In the form of FIG. 10, where there is also a hinge 13 of the male type, it is seen that the connecting area of the fibres 16a, 16b forming the hinge 13 with the fibres 17 forming the structure of the front half-frame 1b, may include a double core filled with two foams 21a, 21b, which may have different characteristics: this allows, if necessary, an enhancement of the characteristics of the stiffener located in the junction area of the beam 1b with its associated front half-frame 3b.

Thus, the precepts described concerning the link between the 12 o'clock beams and the front half-frames may also be transposed to the link between both of these front half-frames and 6 o'clock beams.

What is claimed is:

1. A supporting half-structure for an aircraft engine nacelle, comprising at least one longitudinal beam and a front half-frame connected to each other and formed at least partly in composite materials, characterized in that the half-structure comprises a connecting hinge positioned in a junction area of the longitudinal beam and of the half-frame, the hinge being formed by composite materials laid out so that fibres of the composite materials are positioned in alignment with fibres of composite materials forming said front half-frame.

2. The half-structure according to claim 1, characterized in that said beam is a 12 o'clock beam.

3. The half-structure according to claim 1, characterized in that said beam is a 6 o'clock beam.

4. The half-structure according to claim 2, characterized in that a downstream portion of said hinge is located at right angles to a downstream portion of said front half-frame.

5. The half-structure according to claim 1, characterized in that the fibres of the composite materials forming said hinge converge towards each other to define a space that is filled with foam.

6. The half-structure according to claim 1, characterized in that the fibres forming an upstream portion of said hinge are continuous with fibres forming a stiffener of said front half-frame located in proximity to said junction area.

7. The half-structure according to claim 1, characterized in that said hinge is laid on said beam, wherein the composite materials forming the hinge and the beam share common fibres.

8. The half-structure according to claim 1, characterized in that said hinge is of a female type and includes a downstream yoke and an upstream yoke, each defining an orifice for attaching a connecting rod.

9. The half-structure according to claim 1, characterized in that said hinge is of a male type, and defines a block of composite material defining an orifice for attaching a connecting rod.

10. A nacelle for an aircraft engine, characterized in that the nacelle comprises two half-structures according to claim 1.
